(19) United States
(12) Patent Application Publication
(10) Pub. No.: US 2025/0253440 A1
(43) Pub. Date: Aug. 7, 2025

(54) FLUID EXPANSION TANK

(71) Applicant: MAHLE International GmbH, Stuttgart (DE)

(72) Inventors: Dietmar Wilhelm, Wiernsheim (DE); Michael Braunheim, Goeppingen (DE); Hans-Martin Ruppert, Ostfildren (DE); Ralf Zink, Stuttgart (DE); Stefan Jauss, Donzdorf (DE)

(21) Appl. No.: 19/043,462

(22) Filed: Feb. 1, 2025

(30) Foreign Application Priority Data
Feb. 1, 2024 (DE) 102024102847.5

(51) Int. Cl. H01M 10/6568; B60R 16/033; B60R 16/08; H01M 10/613; H01M 10/625

(52) U.S. Cl. CPC H01M 10/6568; B60R 16/08; H01M 10/613; H01M 10/625; B60R 16/033; H01M 2220/20

(57) ABSTRACT

A fluid equalization tank for equalizing a change in volume of a cooling fluid in a fluid circuit for immersion cooling of a battery of a vehicle is disclosed. with the fluid equalization tank includes a receiving chamber for receiving the cooling fluid and an overflow chamber for receiving the excess cooling fluid from the receiving chamber. The receiving chamber and the overflow chamber are fluidically connected via an overflow duct.

### CROSS-REFERENCE TO RELATED APPLICATION

This application claims priority to German Patent Application No. 102024102847.5 filed Feb. 1, 2024, the contents of which are hereby incorporated by reference in its entirety.

### TECHNICAL FIELD

The invention relates to a fluid equalization tank for equalizing a change in volume of a cooling fluid in a fluid circuit for immersion cooling of a battery of a vehicle.

### BACKGROUND

A battery of a vehicle can be immersion-cooled in a fluid circuit with a cooling fluid such as oil, for example. The fill level of the cooling fluid must be equalized due to a temperature-related change in volume. In order to realize this function, the fluid circuit usually comprises a fluid equalization tank. However, a change in the volume of the cooling fluid can also be caused by ageing of the battery. The age-related change in volume of the cooling fluid is irreversible, meaning that there is always an excess amount of cooling fluid in the fluid circuit as the battery ages. In principle, these changes in volume require compensation in the cooling system, which means that constant ventilation of the fluid equalization tank must be ensured. The excess cooling fluid must be stored in the fluid equalization tank at least temporarily. This requires a larger fluid equalization tank. Ideally, the base area of the fluid equalization tank should not be enlarged in order to prevent additional space from being created by movements of the cooling fluid during operation—for example due to sloshing or inclined positions—while at the same time maintaining the ventilation function.

The task of the invention is therefore to specify an improved or at least alternative embodiment for a fluid equalization tank of the generic type according to the present invention, in which the disadvantages described are overcome.

According to the invention, this task is solved by the object of the independent claim(s). Advantageous embodiments are the object of the dependent claims.

The basic idea of the invention is therefore to collect an excess amount of cooling fluid in an additional overflow tank.

### SUMMARY

The fluid equalization tank according to the invention is provided or designed for equalizing a change in volume of a cooling fluid in a fluid circuit for immersion cooling of a battery of a vehicle. The cooling fluid may in particular be a cooling liquid such as oil. The fluid equalization tank has a receiving chamber for receiving the cooling fluid. Furthermore, the receiving chamber has an inlet for the cooling fluid to flow in from the fluid circuit and an outlet for the cooling fluid to flow out into the fluid circuit. According to the invention, the fluid equalization tank has an overflow chamber for receiving the excess cooling fluid from the receiving chamber. The fluid equalization tank also has an overflow duct that leads from the receiving chamber into the overflow chamber. The overflow chamber and the receiving chamber are fluidically connected to each other exclusively via the overflow duct.

In the fluid equalization tank according to the invention, the excess cooling fluid formed by temperature-related and/or ageing-related volume changes can be directed from the receiving chamber into the overflow chamber and stored there. This allows the excess cooling fluid to be removed from the fluid circuit and simplifies the routing of the cooling fluid in the fluid circuit. Furthermore, the receiving chamber and thus the fluid equalization tank can be made more compact overall.

For emptying, the overflow chamber can have an outlet opening leading to the outside. The outlet opening can be conveniently arranged at the lowest point of the overflow chamber in the fluid equalization tank, which is aligned for operation. The outlet opening can be used to guide the excess cooling fluid from the overflow chamber or from the fluid equalization tank to the outside in a simplified manner. As the excess cooling fluid in the overflow chamber is already separated from the fluid circuit, emptying the overflow chamber has no effect on the required quantity of cooling fluid in the fluid circuit. This makes it particularly easy to remove the excess cooling fluid from the fluid circuit.

To detect the fill level of the excess cooling fluid in the overflow chamber, the fluid equalization tank can have a fill level sensor. The level sensor can be conveniently located in the overflow chamber and send a signal to a user when the overflow chamber is filled. As a result, overfilling of the overflow chamber can be reliably prevented. The overflow chamber can therefore have a relatively small volume or at least a smaller volume than the receiving chamber.

In the fluid circuit, the cooling fluid can flow into the receiving chamber via the inlet and flow out of the receiving chamber via the outlet. The inlet of the fluid equalization tank aligned for operation can be located at the highest point of the receiving chamber and the outlet at the lowest point of the receiving chamber. In this case, the outlet of the receiving chamber can be arranged lower than the outlet opening of the overflow chamber described above in the fluid equalization tank aligned for operation.

The overflow duct can be shaped such that the cooling fluid cannot pass from the overflow chamber into the receiving chamber when the fluid equalization tank is aligned for operation. As a result, the cooling fluid that has entered the overflow chamber from the receiving chamber can no longer enter the receiving chamber and thus back into the fluid circuit. In other words, the cooling fluid can only flow from the receiving chamber into the overflow chamber and not back. The overflow duct can also be shaped such that pressure differences caused by different fill levels of the cooling fluid in the overflow chamber can be compensated for via the overflow duct. Accordingly, the air can flow from the receiving chamber into the overflow chamber and also back via the overflow duct. This allows pressure differences between the receiving chamber and the overflow chamber to be equalized. In particular, this can prevent pressure-related overflow of the cooling fluid from the overflow chamber into the receiving chamber and vice versa.

The overflow duct can have an inlet leading into the receiving chamber and an outlet leading into the overflow chamber. The inlet of the overflow duct can be arranged above the outlet of the overflow duct in the fluid equalization tank aligned for operation. This allows the excess cooling fluid to flow from the inlet to the outlet under the effect of gravity. Furthermore, the cooling fluid entering the overflow duct cannot flow back into the receiving chamber.

The fluid equalization tank may have a wall section formed around the inlet and a wall section formed around the outlet. The wall section formed around the inlet and the wall section formed around the outlet can merge integrally into one another via a stage. In the fluid equalization tank aligned for operation, the wall section formed around the inlet can then be arranged above the wall section formed around the outlet. For example, the stage can be arranged between the inlet of the overflow duct and the outlet of the overflow duct transversely to the direction in which the overflow duct extends. In the fluid equalization tank aligned for operation, the wall sections forming the stage can form a bottom of the overflow duct. Within the overflow duct, the stage can on the one hand support the flow of excess cooling fluid from the inlet to the outlet and on the other hand prevent the cooling fluid from flowing back from the outlet to the inlet.

The fluid equalization tank may have a bulkhead wall. The bulkhead wall can be arranged in the overflow duct transverse to its direction of extension and between the inlet of the overflow duct and the outlet of the overflow duct. The bulkhead wall can reduce the cross-section of the overflow duct through which the flow can pass. The bulkhead wall can be formed on a wall section of the fluid equalization tank that forms the overflow duct. In the fluid equalization tank aligned for operation, the bulkhead wall may be formed from the top to a bottom of the overflow duct. The bulkhead wall can help prevent the cooling fluid from flowing back within the overflow duct of the fluid equalization tank, in particular in the event of rapid changes in the forces acting on the cooling fluid along the direction in which the duct extends.

If the fluid equalization tank has a bulkhead wall and a stage, the bulkhead wall and the stage can be formed on opposite wall sections of the fluid equalization tank forming the overflow duct. The bulkhead wall and the stage can be aligned parallel to each other and a slot through which fluid can flow can be formed between the bulkhead wall and the stage. As described above, in the fluid equalization tank aligned for operation, the stage may be formed at a bottom of the overflow duct and the bulkhead wall may be directed from the top to the bottom of the overflow duct. The bulkhead wall and the stage can be particularly effective in preventing the cooling fluid from flowing back inside the overflow duct.

In one possible embodiment of the fluid equalization tank, the fluid equalization tank may have a housing, wherein the receiving chamber and the overflow chamber and the overflow duct are formed or shaped within the housing. In this regard, wall sections of the housing forming the receiving chamber and the overflow chamber and the overflow duct may merge integrally into each other. In other words, the receiving chamber and the overflow chamber and the overflow duct can be accommodated in the common housing and/or formed inseparably from one another. The housing can be formed or designed in several parts. In particular, the housing can have an upper part and a lower part, which are then connected to each other in a fluid-tight manner. For example, the receiving chamber and the overflow chamber can be formed partially in the upper part and partially in the lower part. The overflow duct can, for example, be formed in the upper part or alternatively in some areas of the upper part and in some areas of the lower part. With this embodiment, the number of hydraulic interfaces between the receiving chamber and the overflow chamber and the number of components can be reduced.

In a possible alternative embodiment of the fluid equalization tank, the fluid equalization tank may have a housing and a channel cover, wherein the receiving chamber and the overflow chamber are formed within the housing and the overflow duct is formed between the housing and the duct cover. Conveniently, a seal can be arranged between the duct cover and the housing, thereby sealing the overflow duct to the outside. In contrast to the embodiment described above, here the duct cover forms the overflow duct in some areas. As in the embodiment described above, the receiving chamber and the overflow chamber remain formed within the housing. Here too, the housing can be formed in several parts. In particular, the housing can have an upper part and a lower part. The overflow duct can then be formed between the upper part of the housing and the duct cover. In this embodiment, the housing and the duct cover can be manufactured in a simplified manner, as no complex structures or molds need to be formed within the housing. In addition, the fluid equalization tank can have a particularly compact design.

Regardless of the embodiment, the housing and possibly the duct cover can be made of plastic. The plastic can, for example, be electrically conductive in order to be able to dissipate electrical charges from the fluid equalization tank. The plastic can, for example, be low-diffusion or diffusion-free in order to prevent water from entering the cooling fluid.

The fluid equalization tank can have a ventilation duct leading out of the receiving chamber. The ventilation duct can, for example, be fluidically connected to an air equalization tank. The ventilation duct can be shaped such that the cooling fluid cannot pass into the ventilation duct when the fluid equalization tank is aligned for operation. The ventilation duct can be designed to compensate for pressure differences caused by different fill levels of the cooling fluid in the receiving chamber. The overflow duct can be arranged or formed inside the ventilation duct. This can simplify the shape and thus the manufacture of the fluid equalization tank.

As described above, the overflow duct can have an inlet leading into the receiving chamber and an outlet leading into the overflow chamber. The ventilation duct can have an inlet leading into the receiving chamber and an outlet leading to the outside. In the fluid equalization tank aligned for operation, the outlet of the ventilation duct may be arranged above the inlet of the ventilation duct. In addition, the inlet of the ventilation duct can be arranged above the inlet of the overflow duct and above the outlet of the overflow duct in the fluid equalization tank aligned for operation. As a result, the overflow duct and the ventilation duct can be combined and yet a fluidic separation can be realized between the ventilation duct through which air can flow and the overflow duct through which the cooling fluid can flow.

As described above, the fluid equalization tank can have a housing. The receiving chamber and the overflow chamber and the overflow duct and the ventilation duct can be formed within the housing. Alternatively, the fluid equalization tank may have a housing and a duct cover, as described above. In this case, the receiving chamber and the overflow chamber can be formed within the housing and the overflow duct and the ventilation duct can be formed between the housing and the duct cover. The housing can be formed as described above.

The fluid equalization tank can also have a water collection chamber and the water collection chamber can be fluidically connected to the receiving chamber. With the fluid equalization tank aligned for operation, the water collection chamber can then be arranged below the receiving chamber so that water that settles out of the cooling fluid within the receiving chamber can collect in the water collection chamber. The water collection chamber and the receiving chamber can, for example, be separated from each other by an anti-surge baffle cover. At least one opening can be provided in the anti-surge baffle cover to allow the water to flow out of the receiving chamber into the water collection chamber.

In addition, it may be provided that the outlet for discharging the cooling fluid into the fluid circuit is arranged at the lowest point of the receiving chamber and a water drain opening for draining the water collected in the water collection chamber is arranged at the lowest point of the water collection chamber. Since the water collection chamber is located below the receiving chamber in the fluid equalization tank aligned for operation, the water drain opening of the water collection chamber is then arranged lower than the outlet of the receiving chamber.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, schematically in each case

FIG. 1 a view of a fluid equalization tank according to the invention in a first embodiment;

FIGS. 2 and 3 sectional views of the fluid equalization tank according to the invention in the first embodiment;

FIG. 4 a sectional view of the fluid equalization tank according to the invention in the first embodiment on a water collection chamber;

FIG. 5 to 9 views of the fluid equalization tank according to the invention in the first embodiment with a comparatively high fill level of the cooling fluid in deviating positions;

FIG. 10 to 14 views of the fluid equalization tank according to the invention in the first embodiment with a comparatively low fill level of the cooling fluid in deviating positions;

FIG. 15 to 19 of the fluid equalization tank according to the invention in the first embodiment with a filled overflow chamber in deviating positions;

FIGS. 20 and 21 views of the fluid equalization tank according to the invention in a second embodiment;

FIG. 22 a view of the fluid equalization tank according to the invention in the second embodiment without duct cover;

FIG. 23 a partial sectional view of the fluid equalization tank according to the invention in the second embodiment without duct cover;

FIGS. 24 and 25 partial sectional views of the fluid equalization tank according to the invention in the second embodiment with the duct cover;

FIG. 26 a sectional view of the fluid equalization tank according to the invention in the second embodiment.

### DETAILED DESCRIPTION

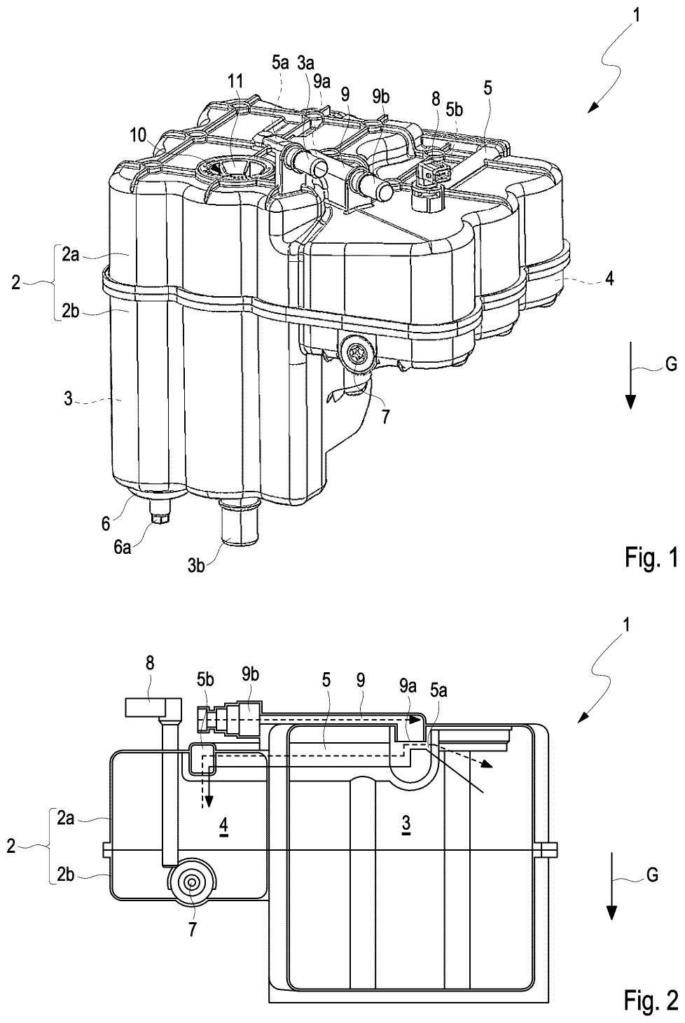

FIG. 1 shows a view of a fluid equalization tank 1 according to the invention in a first embodiment. The fluid equalization tank 1 is designed or intended to equalize a change in volume of a cooling fluid in a fluid circuit for immersion cooling of a vehicle battery. In FIG. 1, the fluid equalization tank 1 is aligned for operation with respect to the gravitational force G. Here and further on, elements of the fluid equalization tank 1 that are not directly visible are marked with broken lines.

The fluid equalization tank 1 has a housing 2 with an upper part 2a and a lower part 2b, which are connected to each other in a fluid-tight manner, for example by welding. The fluid equalization tank 1 comprises a receiving chamber 3 and an overflow chamber 4, which are fluidically connected to each other via an overflow duct 5. The overflow duct 5 has an inlet 5a leading into the receiving chamber 3 and an outlet 5b leading into the overflow chamber 4. The overflow duct 5 is shaped such that the excess cooling fluid can flow from the receiving chamber 3 into the overflow chamber 4 and cannot flow back. This allows the excess cooling fluid, which is caused by a change in volume due to temperature and/or ageing, to be safely stored in the overflow chamber. The receiving chamber 3, the overflow chamber 4 and the overflow duct 5 are formed in the housing 2. The housing 2 can be made of plastic, for example.

The receiving chamber 3 has an inlet 3a leading into the receiving chamber 3 from the outside and an outlet 3b leading out of the receiving chamber 3 to the outside. The receiving chamber 3 of the fluid equalization tank 1 is integrated into the fluid circuit via the inlet 3a and the outlet 3b. For this purpose, the inlet 3a and the outlet 3b can be fluidically connected to other components of the fluid circuit. The fluid circuit and the other components of the fluid circuit are not part of the present invention. The cooling fluid can flow from the fluid circuit into the receiving chamber 3 or into the fluid equalization tank 1 via the inlet 3a and the cooling fluid can flow out of the receiving chamber 3 or out of the fluid equalization tank 1 into the fluid circuit via the outlet 3b. With the fluid equalization tank 1 aligned for operation, the outlet 3b is located as centrally as possible in the recessed region of the receiving chamber 3.

The fluid tank 1 also has a water collection chamber 6 with a water drain opening 6a, which leads out of the water collection chamber 6 to the outside. In the fluid equalization tank 1 aligned for operation, the water collection chamber 6 is located below the receiving chamber 3 and is fluidically connected to the receiving chamber 3, so that water from the cooling fluid can settle downwards and collect in the water collection chamber 6. The water collected in the water collection chamber 6 can be drained via the water drain opening 6a. The water drain opening 6a is conveniently located at the lowest point of the water collection chamber 6 and lower than the outlet 3b of the receiving chamber 3 in the fluid equalization tank 1 aligned for operation. The structure of the water collection chamber 6 is explained in more detail below with reference to FIG. 4.

The fluid equalization tank 1 also has an outlet opening 7 leading out of the overflow chamber 4. The outlet opening 7 is conveniently located at the lowest point of the overflow chamber 4 in the fluid equalization tank 1 aligned for operation. Furthermore, the fluid equalization tank 1 comprises a fill level sensor 8, which detects the fill level of the excess cooling fluid in the overflow chamber 4. If the overflow chamber 4 is full, the user can be informed via a signal from the level sensor 8 and the excess cooling fluid can be manually discharged from the overflow chamber 4 or from the fluid equalization tank 1 to the outside via the outlet opening 7.

Furthermore, the fluid equalization tank 1 has a ventilation duct 9 that leads out of the receiving chamber 3 to the outside. For this purpose, the ventilation duct 9 has an inlet 9a leading into the receiving chamber 3 and an outlet 9b leading to the outside or into an air equalization tank. The receiving chamber 3 can be connected to the air equalization tank via the ventilation duct 9 so that pressure differences caused by different fill levels of the cooling fluid in the receiving chamber 3 can be compensated. The air equalization tank is not part of the present invention.

The fluid equalization tank 1 also has a screw plug 10 and an opening 11. The opening 11 leads from the receiving chamber 3 to the outside and is closed by the screw plug 10. The fluid equalization tank 1 and thus the fluid circuit can be filled with the cooling fluid via the opening 11.

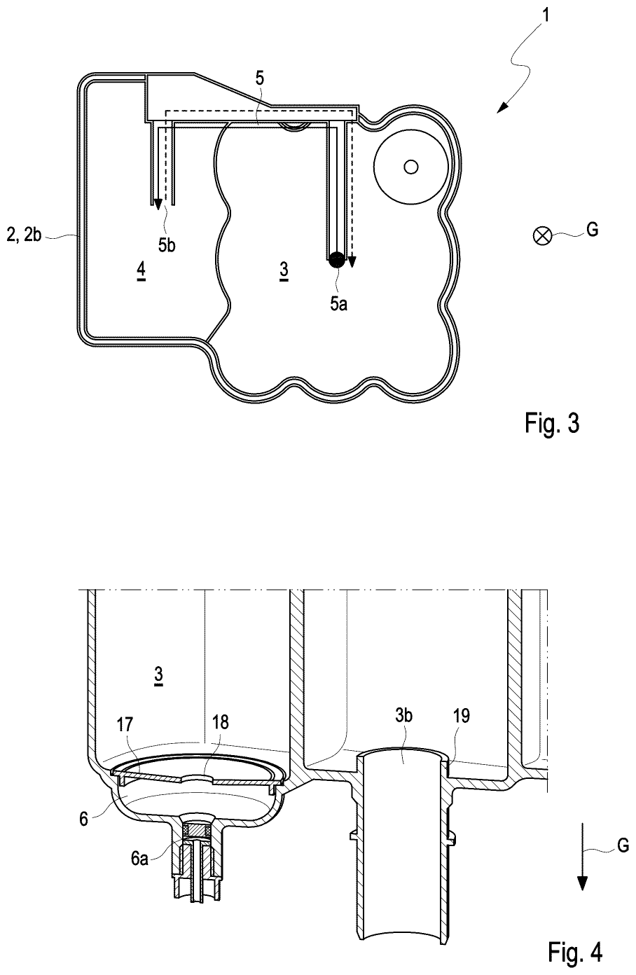

FIG. 2 and FIG. 3 show sectional views of the fluid equalization tank 1 according to the invention in the first embodiment. In the fluid equalization tank 1 aligned for operation, the sectional plane in FIG. 2 is vertical and the sectional plane in FIG. 3 is horizontal. In FIG. 2 and FIG. 3, the direction of flow of the cooling fluid is marked with a solid arrow and the direction of flow of air is marked with a broken arrow. In FIG. 2 and FIG. 3, the fluid equalization tank 1 is aligned for operation with respect to the gravitational force G.

As already indicated above, the excess cooling fluid can flow from the receiving chamber 3 into the overflow chamber 4 and be stored there. In this case, the backflow of the cooling fluid from the overflow chamber 4 into the receiving chamber 3 is excluded or at least largely excluded. However, air from the receiving chamber 3 can enter the overflow chamber 4 via the overflow duct 4, thereby compensating for pressure differences in the overflow chamber 4 caused by different fill levels of the cooling fluid.

In the fluid equalization tank 1, the overflow duct 5 and the ventilation duct 9 are combined. The ventilation duct 9 is arranged above the overflow duct 5 in the fluid equalization tank 1, which is aligned for operation, so that the cooling fluid cannot pass to the outside or into the air equalization tank. With reference to FIG. 2, the outlet 9b of the ventilation duct 9 is located above the inlet 9a of the ventilation duct 9. Furthermore, the inlet 9a of the ventilation duct 9 is located above the inlet 5a and the outlet 5b of the overflow duct 5, so that the cooling fluid cannot pass into the inlet 9a. In addition, the inlet 5a of the overflow duct 5 is located above the outlet 5b, so that the cooling fluid can flow from the inlet 5a to the outlet 5b when it enters the overflow duct 5.

FIG. 4 shows a sectional view of the fluid equalization tank 1 according to the invention in the first embodiment at the water collection chamber 6. It is particularly easy to see here that in the fluid equalization tank 1 aligned for operation, the water collection chamber 6 is located below the receiving chamber 3. The receiving chamber 3 and the water collection chamber 6 are separated from each other by an anti-surge baffle cover 17 and are fluidically connected via an opening 18 in the anti-surge baffle cover 17. In FIG. 4 it can also be seen that a collar 19 projecting into the receiving chamber 3 is formed around the outlet 3b. The collar 19 can prevent water from flowing into the outlet 3b.

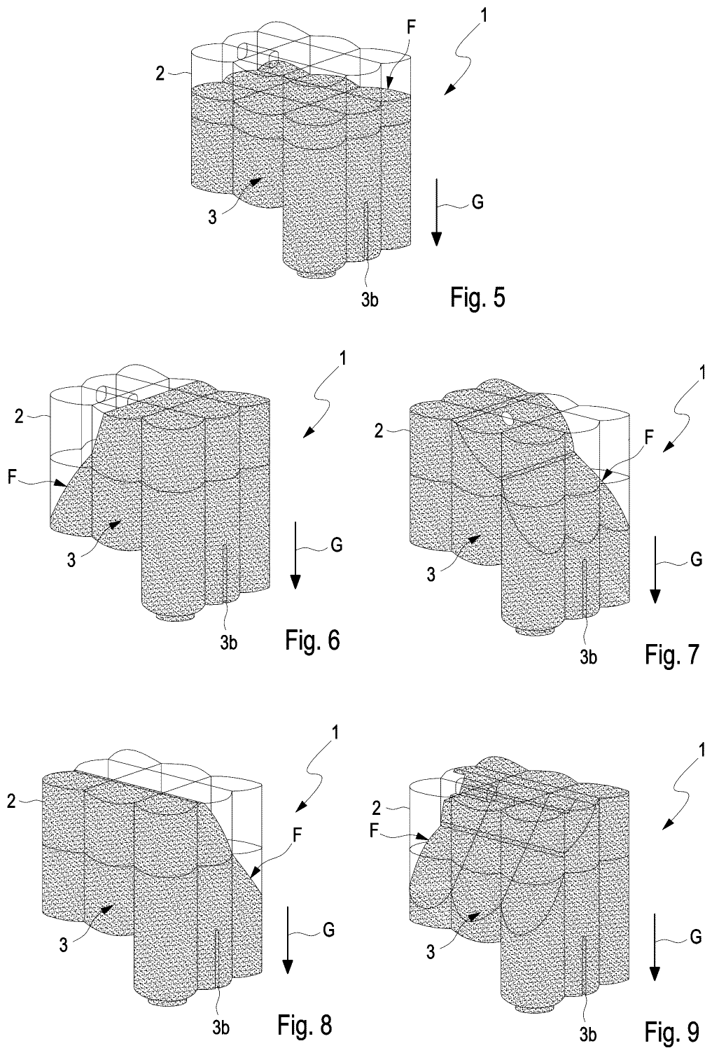

FIG. 5 to FIG. 9 show views of the fluid equalization tank 1 according to the invention in the first embodiment with a comparatively high fill level of the cooling fluid in the receiving chamber 3. In FIG. 5 to FIG. 9, the fluid equalization tank 1 is aligned for operation with respect to the gravitational force G. In FIG. 5, the fluid equalization tank 1 is shown at rest and the fill level F of the cooling fluid is aligned horizontally. Furthermore, the fluid equalization tank 1 is shown braking in FIG. 6, accelerating in FIG. 7, turning in one direction in FIG. 8 and turning in another direction in FIG. 9. In FIG. 6 to FIG. 9, the fill level F of the cooling fluid is inclined according to the forces acting. As can be seen from FIG. 5 to FIG. 9, a sufficient amount of the cooling fluid remains at the outlet 3b of the receiving chamber 3 with any orientation of the fill level F of the cooling fluid, so that the fluid circuit is always supplied with the cooling fluid. In addition, it should be ensured that no cooling fluid enters the inlet 5a of the overflow duct 5 as long as there is no additional volume in the receiving chamber 3 resulting from the ageing of the battery, so that the cooling fluid is not withdrawn from the fluid circuit without necessity.

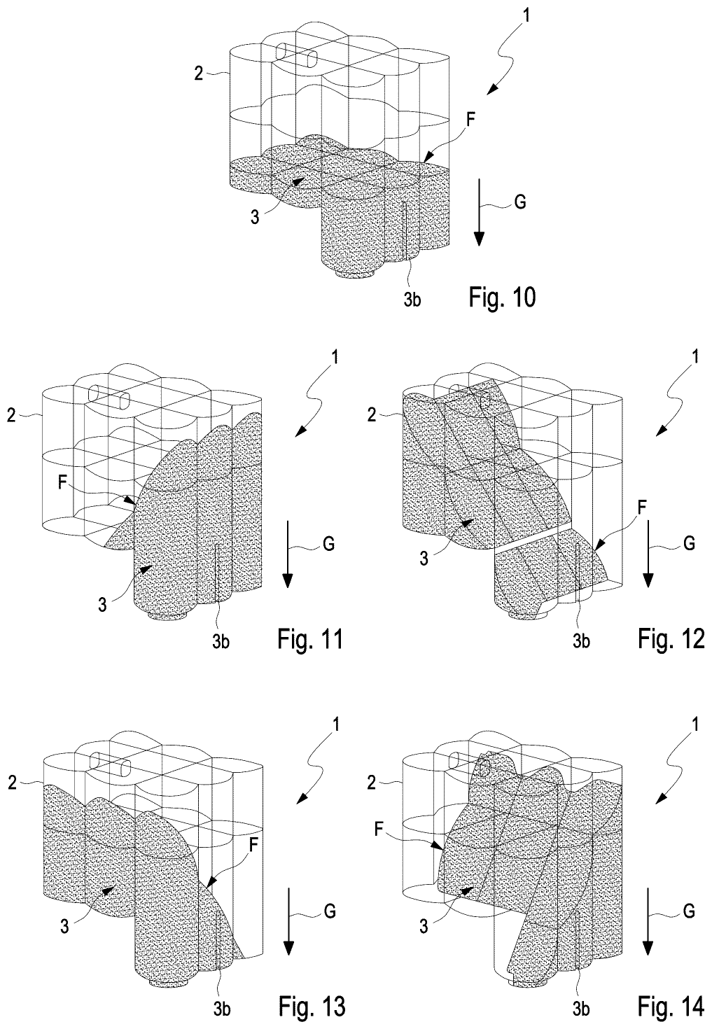

FIG. 10 to FIG. 14 show views of the fluid equalization tank 1 according to the invention in the first embodiment with a comparatively low fill level of the cooling fluid in the receiving chamber 3. In FIG. 10 to FIG. 14, the fluid equalization tank 1 is aligned for operation with respect to the gravitational force G. The fluid equalization tank 1 is shown at rest in FIG. 10, during braking in FIG. 11, during acceleration in FIG. 12, during turning in one direction in FIG. 13 and during turning in another direction in FIG. 14. As can be seen from FIG. 10 to FIG. 14, a sufficient amount of cooling fluid remains at the outlet 3b of the receiving chamber 3, even with any orientation of the fill level F of the cooling fluid, so that the fluid circuit is always supplied with the cooling fluid.

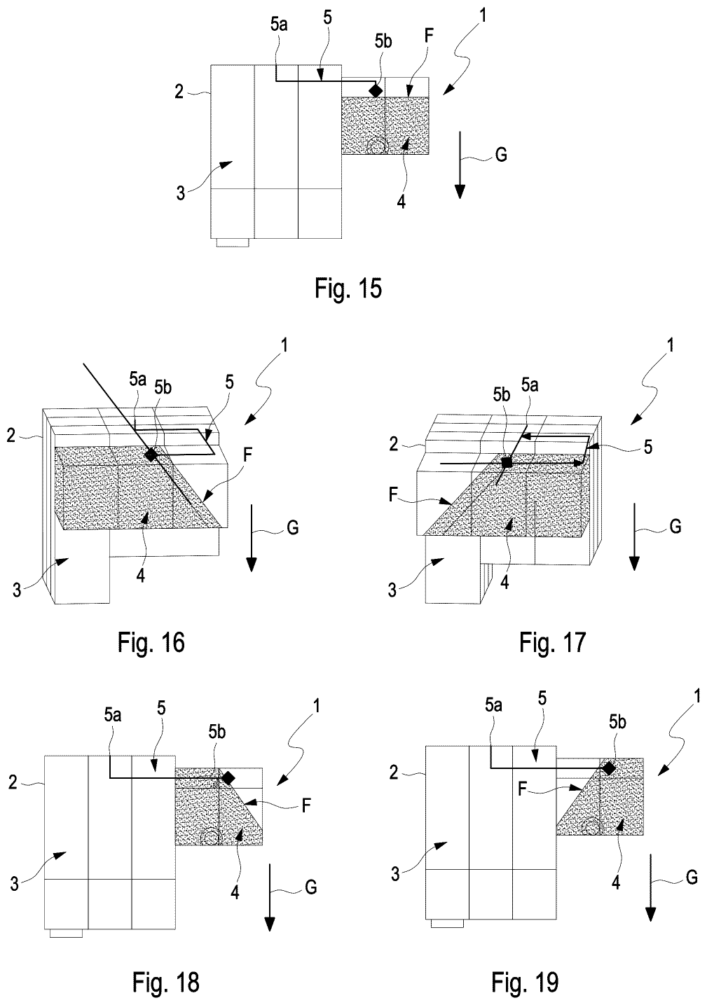

FIG. 15 to FIG. 19 show views of the fluid equalization tank 1 according to the invention in the first embodiment with the filled overflow chamber 4. In FIG. 15 to FIG. 19, the fluid equalization tank 1 is aligned for operation with respect to the gravitational force G. The fluid equalization tank 1 is shown at rest in FIG. 15, during braking in FIG. 16, during acceleration in FIG. 17, during turning in one direction in FIG. 18 and during turning in another direction in FIG. 19. As can be seen from FIG. 15 to FIG. 19, it is important to ensure that no cooling fluid in the overflow chamber 4 rises to the outlet 5b of the overflow duct 5 when the fluid is inclined. This means that the cooling fluid cannot get from the overflow chamber 4 into the receiving chamber 3 if the fill level F is not aligned.

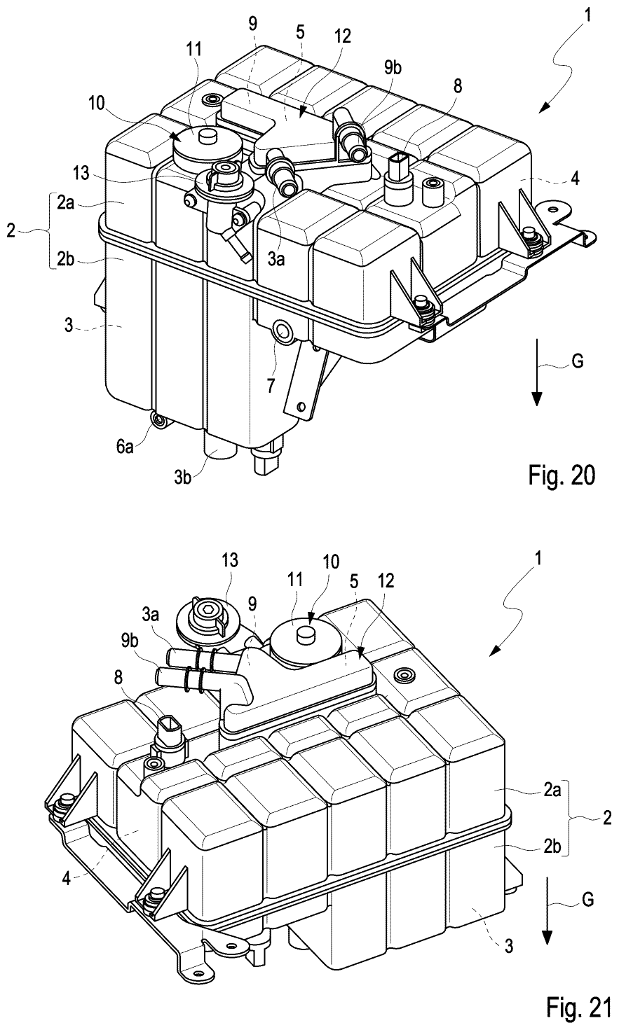

FIG. 20 and FIG. 21 show views of the fluid equalization tank 1 according to the invention in a second embodiment. In FIG. 20 and FIG. 21, the fluid equalization tank 1 is aligned for operation with respect to the gravitational force G. In contrast to the first embodiment, the fluid equalization tank 1 here has the housing 2 and a duct cover 12. The overflow duct 5 and the ventilation duct 9 are formed between the housing 2 and between the upper part 2a of the housing 2 and the duct cover 12. FIG. 20 and FIG. 21 also show a shut-off valve 13.

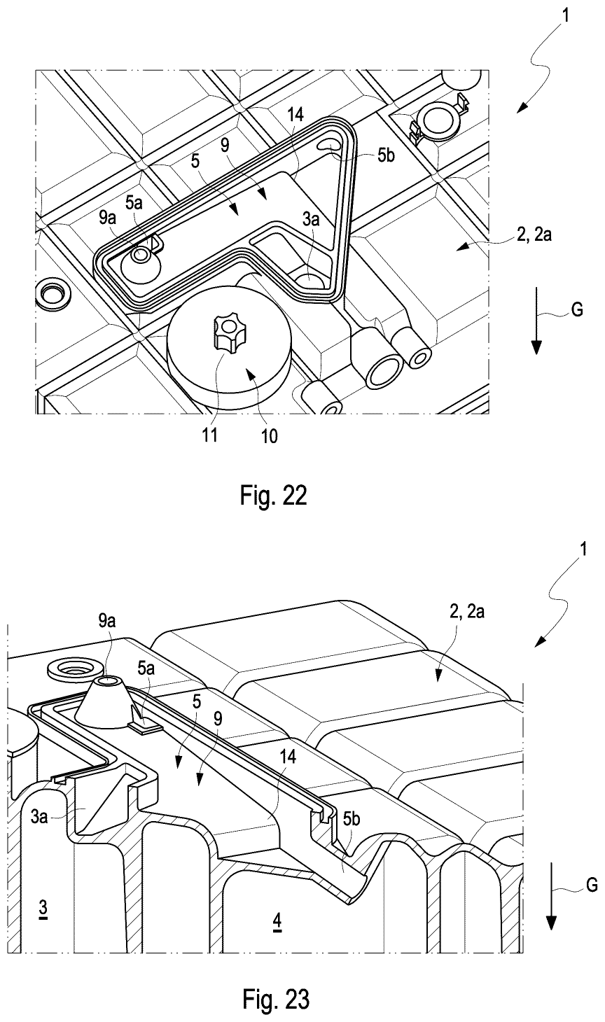

FIG. 22 shows a view of the fluid equalization tank 1 according to the invention in the second embodiment without the duct cover 12. Here, the fluid equalization tank 1 is aligned for operation with respect to the gravitational force G. As can be seen in FIG. 22, the inlet 5a of the overflow duct 5 is located above the outlet 5b of the overflow duct 5, so that the cooling fluid can flow from the inlet 5a to the outlet 5b as it enters the overflow duct 5. Furthermore, the inlet 9a of the ventilation duct 9 is located above the inlet 5a and the outlet 5b of the overflow duct 5, so that the cooling fluid cannot pass into the inlet 9a. Furthermore, a stage 14 is arranged in the overflow duct 5 between the inlet 5a and the outlet 5b, which prevents the cooling fluid from flowing back into the overflow duct 5. In FIG. 22, the inlet 3a into the receiving chamber 3 is also visible, which is partially surrounded to the outside by the duct cover 12. The inlet 3a is appropriately fluidically separated from the overflow duct 5 and the ventilation duct 9 by the duct cover 12.

FIG. 23 shows a partial sectional view of the fluid equalization tank 1 according to the invention in the second embodiment without duct cover 12. In FIG. 23, the fluid equalization tank 1 is aligned for operation with respect to the gravitational force G. In FIG. 23, the stage 14 and the inclination of the overflow duct 5 from the inlet 5a to the outlet 5b can be seen in particular.

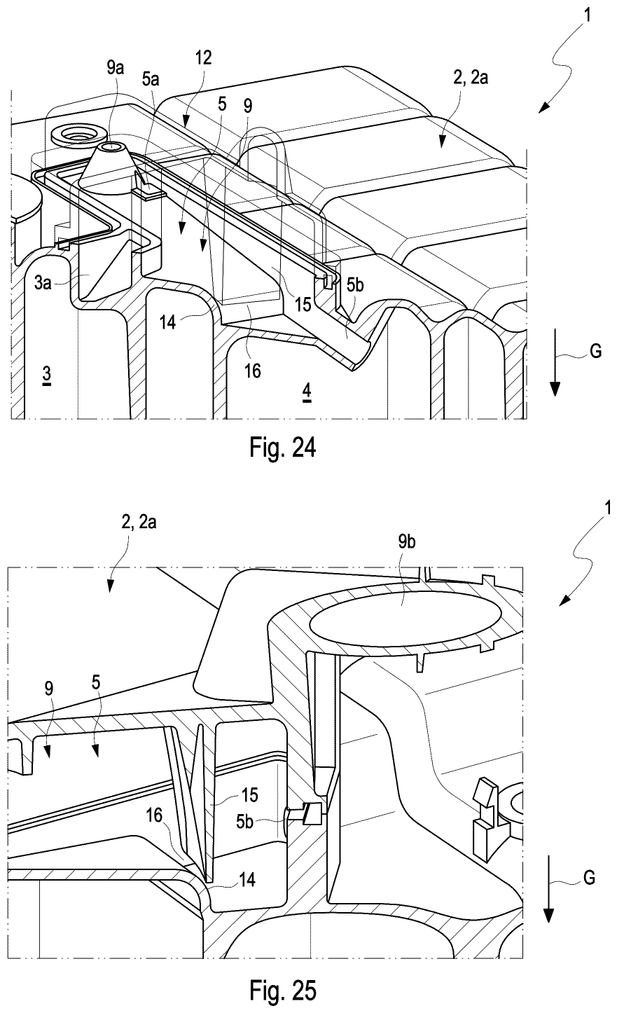

FIG. 24 and FIG. 25 show partial sectional views of the fluid equalization tank 1 according to the invention in the second embodiment with the duct cover 12. Here, the fluid equalization tank 1 is aligned for operation with respect to the gravitational force G. In FIG. 24 and in FIG. 25, it can be seen that a bulkhead wall 15 is formed on the duct cover 12, which protrudes into the overflow duct 5 and is arranged at the stage 13. The bulkhead wall 15 can prevent or at least make it more difficult for the cooling fluid to spill over from the overflow chamber 4 into the receiving chamber 3. A slot 16 is formed between the bulkhead wall 15 and the stage 13, which allows the cooling fluid to flow from the receiving chamber 3 into the overflow chamber 4.

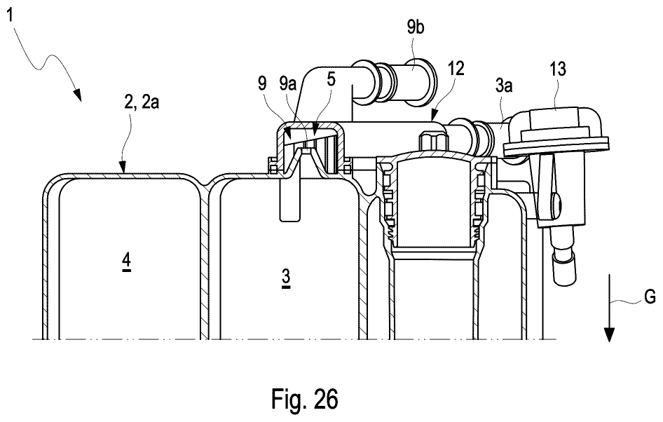

FIG. 26 shows a sectional view of the fluid equalization tank 1 according to the invention in the second embodiment. Here, the fluid equalization tank 1 is aligned for operation with respect to the gravitational force G. FIG. 26 shows in particular the inlet 9a of the ventilation duct 9.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A fluid equalization tank for equalizing a change in volume of a cooling fluid in a fluid circuit for immersion cooling of a battery of a vehicle, comprising:
a receiving chamber for receiving the cooling fluid,
the receiving chamber having an inlet for the cooling fluid to flow in from the fluid circuit and an outlet for the cooling fluid to flow out into the fluid circuit,
an overflow chamber for receiving excess cooling fluid from the receiving chamber,
an overflow duct leading from the receiving chamber into the overflow chamber, and
wherein the receiving chamber and the overflow chamber are fluidically connected to each other exclusively via the overflow duct.

2. The fluid equalization tank according to claim 1, wherein:
the overflow duct is shaped such that the cooling fluid cannot pass from the overflow chamber into the receiving chamber when the fluid equalization tank is aligned for operation, and/or
the overflow duct is shaped such that pressure differences caused by different fill levels of the cooling fluid in the overflow chamber can be equalized via the overflow duct.

3. The fluid equalization tank according to claim 1, wherein:
the overflow duct has an inlet leading into the receiving chamber and an outlet leading into the overflow chamber, and
the inlet of the overflow duct is arranged above the outlet of the overflow duct in the fluid equalization tank aligned for operation.

4. The fluid equalization tank according to claim 3, wherein:
a wall section is disposed around the inlet of the overflow duct and a wall section is disposed around the outlet of the overflow duct,
the wall section disposed around the inlet and the wall section disposed around the outlet merge integrally into each other via a stage, and
in the fluid equalization tank aligned for operation, the wall section disposed around the inlet is arranged above the wall section disposed around the outlet.

5. The fluid equalization tank according to claim 3, wherein:
a bulkhead wall is provided and arranged in the overflow duct transversely to its direction of extension, and
the bulkhead wall is arranged between the inlet of the overflow duct and the outlet of the overflow duct and reduces a cross-section of the overflow duct through which flow can pass.

6. The fluid equalization tank according to claim 5, wherein:
the bulkhead wall and the stage are formed on opposite wall sections of the fluid equalization tank forming the overflow duct and are aligned parallel to each other, and
a flow-through slot is formed between the bulkhead wall and the stage.

7. The fluid equalization tank according to claim 1, further comprising:
a housing, wherein the receiving chamber and the overflow chamber and the overflow duct are formed within the housing, or
a housing and a duct cover, wherein the receiving chamber and the overflow chamber are formed within the housing and the overflow duct is formed between the housing and the duct cover.

8. The fluid equalization tank according to claim 1, wherein:
a ventilation duct is provided and leads out of the receiving chamber to the outside,
the ventilation duct is shaped such that the cooling fluid cannot pass into the ventilation duct when the fluid equalization tank is properly aligned for operation, and
the overflow duct is arranged inside the ventilation duct.

9. The fluid equalization tank according to claim 8, wherein:
the overflow duct has an inlet leading into the receiving chamber and an outlet leading into the overflow chamber,
the ventilation duct has an inlet leading into the receiving chamber and an outlet leading to the outside,
in the fluid equalization tank aligned for operation, the outlet of the ventilation duct is arranged above the inlet of the ventilation duct, and
in the fluid equalization tank aligned for operation, the inlet of the ventilation duct is arranged above the inlet of the overflow duct and above the outlet of the overflow duct.

10. The fluid equalization tank according to claim 8, further comprising:
a housing, wherein the receiving chamber and the overflow chamber and the overflow duct and the ventilation duct are formed within the housing, or
a housing and a duct cover, wherein the receiving chamber and the overflow chamber are formed within the housing, and the overflow duct and the ventilation duct are formed between the housing and the duct cover.

11. The fluid equalization tank according to claim 1, wherein:
a water collection chamber is provided and is fluidically connected to the receiving chamber, and
the water collection chamber is arranged below the receiving chamber in the fluid equalization tank aligned for operation, so that water that settles from the cooling fluid inside the receiving chamber can collect in the water collection chamber.

12. The fluid equalization tank according to claim 11, wherein:
the outlet for discharging the cooling fluid into the fluid circuit is arranged at a lowest point of the receiving chamber and a water drain opening for draining the water collected in the water collection chamber is arranged at a lowest point of the water collection chamber, and
the water drain opening is arranged below the outlet in the fluid equalization tank aligned for operation.

13. A vehicle, comprising:
a fluid circuit for a cooling fluid for immersion cooling of a battery of the vehicle, and
a fluid equalization tank for equalizing a change in volume of the cooling fluid in the fluid circuit, the fluid equalization tank including:
a receiving chamber for receiving the cooling fluid,
the receiving chamber having an inlet for the cooling fluid to flow in from the fluid circuit and an outlet for the cooling fluid to flow out into the fluid circuit,
an overflow chamber for receiving excess cooling fluid from the receiving chamber,
an overflow duct leading from the receiving chamber into the overflow chamber, and
wherein the receiving chamber and the overflow chamber are fluidically connected to each other exclusively via the overflow duct.

14. The vehicle according to claim 13, wherein:
the overflow duct is shaped such that the cooling fluid cannot pass from the overflow chamber into the receiving chamber when the fluid equalization tank is aligned for operation, and/or
the overflow duct is shaped such that pressure differences caused by different fill levels of the cooling fluid in the overflow chamber can be equalized via the overflow duct.

15. The vehicle according to claim 13, wherein:
the overflow duct has an inlet leading into the receiving chamber and an outlet leading into the overflow chamber, and
the inlet of the overflow duct is arranged above the outlet of the overflow duct in the fluid equalization tank aligned for operation.

16. The vehicle according to claim 15, wherein:
a wall section is disposed around the inlet of the overflow duct and a wall section is disposed around the outlet of the overflow duct,
the wall section disposed around the inlet and the wall section disposed around the outlet merge integrally into each other via a stage, and
in the fluid equalization tank aligned for operation, the wall section disposed around the inlet is arranged above the wall section disposed around the outlet.

17. The vehicle according to claim 15, wherein:
a bulkhead wall is provided and arranged in the overflow duct transversely to its direction of extension, and
the bulkhead wall is arranged between the inlet of the overflow duct and the outlet of the overflow duct and reduces a cross-section of the overflow duct through which flow can pass.

18. The vehicle according to claim 17, wherein:
the bulkhead wall and the stage are formed on opposite wall sections of the fluid equalization tank forming the overflow duct and are aligned parallel to each other, and
a flow-through slot is formed between the bulkhead wall and the stage.

19. The vehicle according to claim 13, further comprising:
a housing, wherein the receiving chamber and the overflow chamber and the overflow duct are formed within the housing, or
a housing and a duct cover, wherein the receiving chamber and the overflow chamber are formed within the housing and the overflow duct is formed between the housing and the duct cover.

20. The vehicle according to claim 13, wherein:
a ventilation duct is provided and leads out of the receiving chamber to the outside,
the ventilation duct is shaped such that the cooling fluid cannot pass into the ventilation duct when the fluid equalization tank is properly aligned for operation, and
the overflow duct is arranged inside the ventilation duct.
